(19) United States
(12) Patent Application Publication
(10) Pub. No.: US 2012/0138840 A1
(43) Pub. Date: Jun. 7, 2012

(54) INTAKE AND EXHAUST VALVE FOR VEHICLE

(75) Inventor: Ha Dong Bong, Ansan-city (KR)

(73) Assignees: Kia Motors Corporation, Seoul (KR); Hyundai Motor Company, Seoul (KR)

(21) Appl. No.: 13/190,344

(22) Filed: Jul. 25, 2011

(30) Foreign Application Priority Data
Dec. 2, 2010 (KR) 10-2010-0122239

(51) Int. Cl. F16K 27/00

(52) U.S. Cl. 251/366

(57) ABSTRACT

An intake/exhaust valve for a vehicle to prevent the valve from fixation (valve absorption) may include a first valve stem body which is extruded from a valve head, has a first diameter and is a portion where a relative motion of a valve stem occurs; and a second valve stem body which is formed above the first valve stem body and has a second diameter. The second diameter is less than the first diameter. The relative clearance between the first valve stem body and a valve guide is predetermined for stable guiding of a valve closing, and the relative clearance between the second valve stem body and the valve guide is predetermined for preventing carbon fixation.

### CROSS-REFERENCE TO RELATED APPLICATION

The present application claims priority of Korean Patent Application Number 10-2010-0122239 filed in the Korean Intellectual Property Office on Dec. 2, 2010, the entire contents of which application is incorporated herein for all purposes by this reference.

### BACKGROUND OF INVENTION

1. Field of Invention

The present invention relates to an intake/exhaust valve for a vehicle. More particularly, the present invention relates to an intake/exhaust valve for a vehicle which may prevent the valve from fixation (valve absorption).

2. Description of Related Art

Generally, an intake/exhaust valve for a vehicle has a constant diameter from top to bottom as relative movement portion. In this case, abnormal valve movement (valve failure) may occur in conventional intake/exhaust valves due to carbon absorption (carbon fixation). The abnormal valve movement may happen when a valve is fixed to a valve guide and thus is not closed.

By experiments, it is clear that the main cause of the valve failure is due to the deposited carbon on the valve stem. That is, deposited fixation of carbon occurs when the carbon is deposited to a valve head after using especially abnormal fuel such as low quality fuel, fuel without additive or insufficient additive and so on, and the deposited carbon on the valve head is dragged up to a relative movement portion of a valve stem during reciprocation of the valve. And then the deposited carbon induces valve fixation (valve absorption).

It is not a problem of an engine hardware but a problem of the characteristics of the fuel. To reduce or solve the problem, it is necessary to apply detergent dispersant repeatedly. That is, increasing clearance of the valve stem is required in view of design and repeatedly applying detergent dispersant is required for preventing carbon fixation.

However, if clearance of the valve stem is increased, valve motion may be unstable when the valve is closed and thus it may induce biased wearing of the valve seat or the valve. That is, increasing clearance of the valve stem is required for preventing carbon fixation, but it has to be limited for stable valve motion.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention have been made in an effort to provide an intake/exhaust valve for a vehicle having advantages of preventing the valve from fixation with stable valve motion.

Exemplary intake/exhaust valves for a vehicle according to the present invention may include a first valve stem body which is extruded from a valve head with a first diameter and is a portion where relative motion of a valve stem occurs, and a second valve stem body which is formed above the first valve stem body and has a second diameter, wherein the second diameter is less than the first diameter.

A portion is formed between the second valve stem body and the first valve stem body with a varied diameter. Preferably, the diameter is changed linearly.

A length of the first valve stem body may be a predetermined length for preventing the valve from interference. The predetermined length may be determined so that when the valve is positioned at the lowest potion, the valve position is not corresponding to a piston top dead center position.

Other exemplary intake/exhaust valves for a vehicle according to the present invention may include a first valve stem body which is extruded from a valve head with a first diameter and is a portion where relative motion of a valve stem occurs, and a second valve stem body which is formed above the first valve stem body and has a second diameter, wherein a relative clearance between the first valve stem and a valve guide is predetermined for stable guiding of valve closing, and a relative clearance between the second valve stem and the valve guide is predetermined for preventing carbon fixation.

A length of the first valve stem body may be a predetermined length for stable guiding of the valve closing. The valve fixation may be prevented with stable valve motion.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a drawing of an exemplary intake/exhaust valve for a vehicle according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Exemplary embodiments of the present invention will hereinafter be described in detail with reference to the accompanying drawings.

In an experiment, a portion where valve fixation may be occurred may distinct from a portion where valve movement is considered.

That is, the portion related to valve fixation may be considered where a valve is opened when an engine stops. After valve fixation occurs from carbon fixation, a piston moves upward and the valve may be broken or bent in the engine due to the interference between the valve and the piston, and thus the engine failure may occur.

Meanwhile, the portion related valve movement may be considered where the valve is closed and vibration or oscillation is occurred. Wearing or abrasion of the valve or the valve seat may occur so that combustion gas may be leaked. And then valve melting may be occurred and thus the engine failure may occur.

That is, the portion related to the valve fixation is the portion where the valve is opened, and the portion related to the valve movement is where the valve is closed.

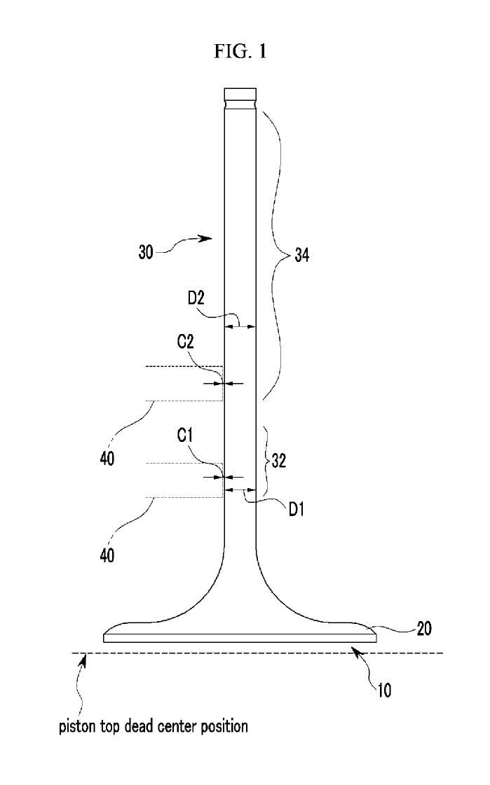

Referring to FIG. 1, an intake/exhaust valve for a vehicle 10 according to the present invention includes a first valve stem body 32 which is extruded from a valve head 20 and has a first diameter D1 and the first valve stem body 32 is a portion where relative motion of a valve stem occurs, and a second valve stem body 34 which is formed above the first valve stem body 32 and has a second diameter D2, wherein the second diameter D2 is less than the first diameter D1.

That is, relative movement portion of the valve stem has two different diameters. The second diameter D2 may be 20 μm smaller than the first diameter D1.

A portion is formed between the second valve stem body 34 and the first valve stem body 32 with a varied diameter. Preferably, the diameter is changed linearly.

The exemplary intake/exhaust valve for a vehicle 10 according to the present invention has a stem 30 of which a portion where the valve is opened based on a valve guide 40 has a relatively larger clearance C2 and of which a portion where the valve will be closed based on the valve guide 40 has a relatively smaller clearance C1.

For example, clearance C2 of the portion related to valve fixation may be 0.040-0.060 mm and clearance C1 of the portion related valve movement may be 0.020-0.040 mm.

A length of the first valve stem body 32 may be a predetermined length for preventing the valve from interference. The predetermined length may be determined so that when the valve is positioned at the lowest potion, the valve position is not corresponding to a piston top dead center position.

That is, the predetermined length is determined based on preventing interference between the valve and the piston and thus the valve fixation may be prevented with stable valve movement.

The predetermined length may be determined by considering engine types, the valve lift and the interference at top dead center. It may be less than 6 mm. That is, the length of the first valve stem body 32 may be a predetermined length for stable guiding of the valve closing.

For convenience in explanation and accurate definition in the appended claims, the terms “smaller” or “larger”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An intake/exhaust valve for a vehicle comprising:
a valve head;
a first valve stem body which is extruded from the valve head, has a first diameter and is a portion where a relative motion of a valve stem occurs; and
a second valve stem body which is formed above the first valve stem body and has a second diameter;
wherein the second diameter is less than the first diameter.

2. The intake/exhaust valve of claim 1, wherein a portion is formed between the first valve stem body and the second valve stem body with a varied diameter.

3. The intake/exhaust valve of claim 2, wherein the diameter of the portion between the first valve stem body and the second valve stem body changes linearly.

4. The intake/exhaust valve of claim 1, wherein a length of the first valve stem body is a predetermined length for preventing the valve from interference.

5. The intake/exhaust valve of claim 4, wherein the predetermined length is determined so that when the valve is positioned at a lowest potion, the lowest position of the valve is not corresponding to a piston top dead center position.

6. The intake/exhaust valve of claim 1, wherein the second diameter is approximately 20 μm smaller than the first diameter.

7. An intake/exhaust valve for a vehicle comprising:
a valve head;
a first valve stem body which is extruded from a valve head, has a first diameter and is a portion where a relative motion of a valve stem occurs; and
a second valve stem body which is formed above the first valve stem body and has a second diameter;
wherein a relative clearance between the first valve stem body and a valve guide is predetermined for stable guiding of a valve closing, and
a relative clearance between the second valve stem body and the valve guide is predetermined for preventing a valve fixation.

8. The intake/exhaust valve of claim 7, wherein a length of the first valve stem body is a predetermined length for stable guiding of the valve closing.

9. The intake/exhaust valve of claim 7, wherein the relative clearance between the first valve stem body and the valve guide is approximately 0.020-0.040 mm, and the relative clearance between the second valve stem body and the valve guide is approximately 0.040-0.060 mm.
